(19) United States
(12) Patent Application Publication
(10) Pub. No.: US 2013/0013396 A1
(43) Pub. Date: Jan. 10, 2013

(54) SYSTEM AND METHOD TO PERFORM EXPOSURE AND CONVERSION ANALYSIS

(75) Inventors: Michael Vinson, Piedmont, CA (US); Bruce Goerlich, Portland, OR (US); Kristie Fortner, Happy Valley, OR (US)

(73) Assignee: Rentrak Corporation, Portland, OR (US)

(21) Appl. No.: 13/543,765

(22) Filed: Jul. 6, 2012

Related U.S. Application Data
(60) Provisional application No. 61/504,997, filed on Jul. 6, 2011.

(51) Int. Cl. G06Q 30/02

(52) U.S. Cl. 705/14.45

(57) ABSTRACT

A system and method to measure the effectiveness of advertisements. The effectiveness of a particular target portion of an advertising campaign (e.g., related to an advertisement or advertisements appearing on a specific network, time of the day, program, etc.) is determined relative to exposures to other portions of the advertising campaign. To facilitate the measurement, the system constructs an exposure interaction matrix, which allows isolation of the effectiveness of one group of advertisement exposures while controlling for exposures across other groups. For each cell of the matrix, the system computes an index. The index indicates how much the target advertisements influenced the conversion decision, relative to the entire campaign. A plurality of exposure interaction matrices may be determined for a plurality of target portions and compared to one another in order to determine a desired advertising schedule.

### CROSS-REFERENCE TO RELATED APPLICATION(S)

This application claims the benefit of U.S. Provisional Patent Application No. 61/504,997, entitled “System and Method to Perform Exposure and Conversion Analysis” and filed Jul. 6, 2011, which is incorporated herein by reference in its entirety.

### BACKGROUND

Advertisers want to know how effective their advertisements are. In particular, they want to know, for any given number of exposures, how effective the advertisements are in driving consumer behavior. In some cases, it is possible to connect “conversion”—meaning, purchase of a product or service following viewing of an advertisement—directly at the household level to corresponding set top box (STBs)-based TV viewing behavior. In particular, the likelihood of conversion or sales success can be in some instances related to frequency of household-level advertisement exposure. Advertisers want to know, moreover, which specific networks, programs, times of day, ad copies, etc. drove the most conversion. However, when a consumer is exposed to multiple advertisements (i.e. cross-exposure), it may be difficult to know which advertisements drove the purchase. Thus, there is a need for an improved system that can account for cross-exposure in determining the effectiveness of advertisements.

### BRIEF DESCRIPTION OF THE DRAWINGS

FIG. 1 is a schematic diagram depicting an embodiment of an exposure and conversion analysis system.

FIG. 2 is a flowchart showing an embodiment of a method for forming an exposure interaction matrix.

FIG. 3 is a diagram depicting a representative exposure interaction matrix formed in accordance with the method of FIG. 2.

FIG. 4 is a flowchart showing an embodiment of a method for determining a media plan by constructing and analyzing a series of exposure interaction matrixes.

### DETAILED DESCRIPTION

An advertising “campaign” is the delivery of one or more related advertisements across one or more distribution networks at different times and/or days. Disclosed herein is a system and method to measure the effectiveness of advertisements in driving purchase behavior, and in particular to disentangle the effectiveness of a particular target portion of a campaign (which might refer to a specific network on which an advertisement appears, or time of day on a given network, or program, or ad copy, etc.) from exposures to other non-target portions of the campaign. To facilitate the measurement of the effectiveness of advertisements at this level of specificity, the system constructs an “exposure interaction matrix” (EIM), which allows isolation of the effectiveness of one group of advertisement exposures while controlling for exposures across other groups.

In some embodiments, the exposure interaction matrix comprises a number of exposures to target advertisements along one axis and a number of exposures to non-target advertisements along the other axis. Household viewing data is reviewed as compared to an advertising campaign schedule in order to measure how many times the household was exposed to target advertisements and non-target advertisements. In accordance with the number of exposures to target advertisements and non-target advertisements, a corresponding cell in the exposure interaction matrix is determined and a record is kept of which households converted (i.e. purchased the advertised product or service) or did not convert. This process is repeated for all of the households in a geographic area that is being analyzed. A conversion rate is then computed for each cell, which comprises a ratio of the number of converted households in the cell to a total number of households in the cell. In addition, a conversion rate is computed for each total number of exposures, which comprises a ratio of a number of converted households relative to a given total number of exposures. An index for each cell is calculated as the conversion rate of the cell, divided by the overall conversion rate for x+y exposures. The index therefore indicates how much the target advertisements influenced the conversion decision, relative to the entire campaign.

In some embodiments, a plurality of target advertisements are determined which are to be analyzed and an exposure interaction matrix is constructed for each target. All of the exposure interaction matrices are then analyzed relative to one another in order to determine a media plan (e.g., an advertising campaign) that attempts to maximize conversion rate.

Various embodiments of the invention are described below. The following description provides specific details for a thorough understanding and an enabling description of these embodiments. One skilled in the art will understand, however, that the invention may be practiced without many of these details. In addition, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

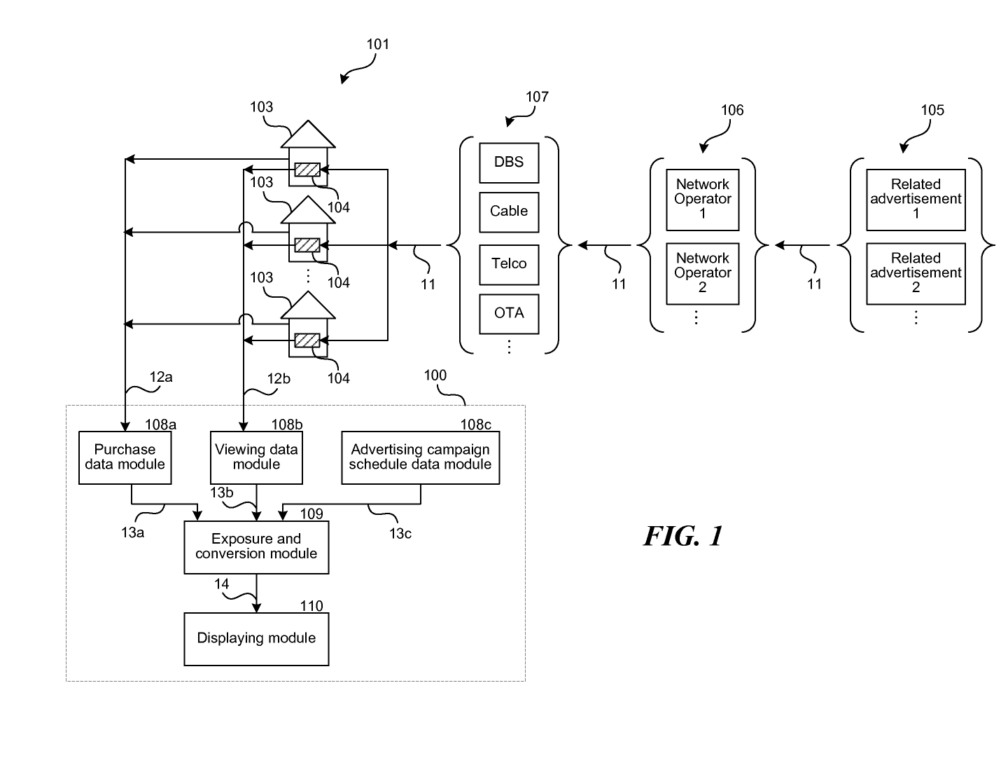

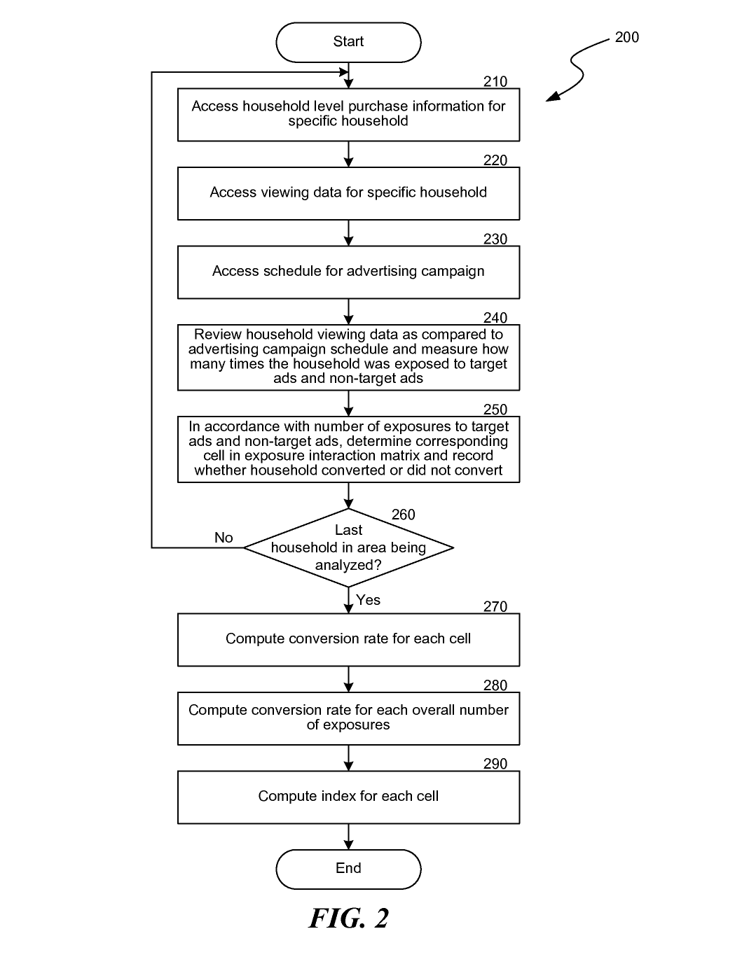

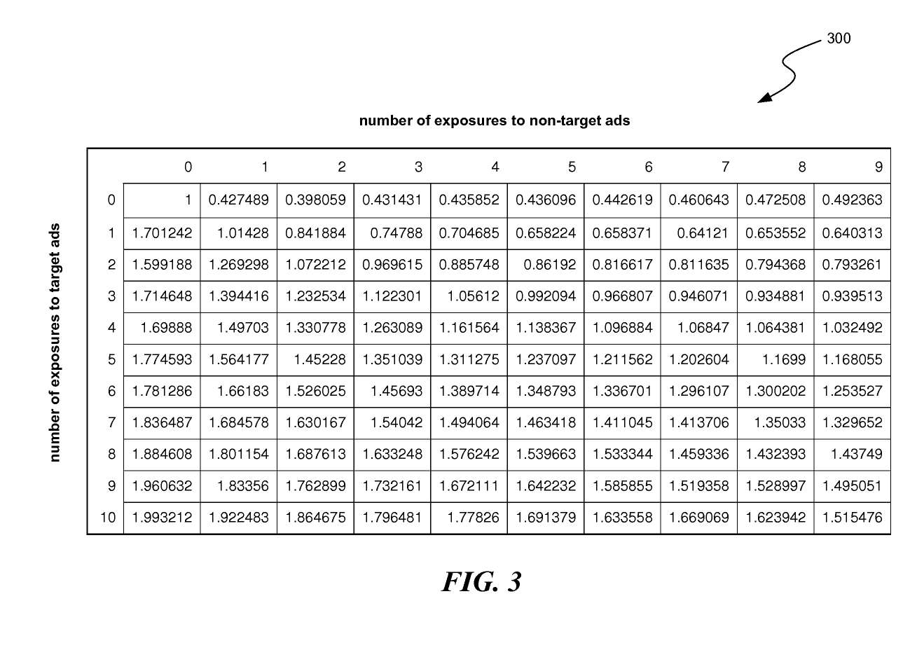

FIG. 1 is a schematic diagram depicting an embodiment of an exposure and conversion analysis system 100. In FIG. 1, a predetermined area 101 indicates a geographic area (or market) for which the exposure and conversion analysis system 100 is used to make an exposure interaction matrix, as will be described in more detail below with respect to FIGS. 2 and 3. The predetermined area 101 includes a plurality of households 103 which each have one or more household devices 104 installed. Households may be single family homes, multiple-family homes, apartments, condos, dormitories, or any other unit of housing associated with one or more individuals.

Each subscriber controls which program content they view with the assistance of a household device 104. In some embodiments, a household device 104 can be a set-top unit (STU) or one of various types of a set-top box (STB), such as a cable television converter, satellite receiver, or other similar devices such as gaming stations (e.g. Microsoft X-box) and the like, as well as integrated electronic components (e.g., tuners in a smart television) which allow a user to tune to a desired audio/video stream. In some embodiments, the household device 104 can be a hybrid set-top box (HSTB) that allows various methods of data transmission, such as, cables, satellites, telecommunication and Internet. The household device 104 may include digital video recorder “DVR” capability (e.g. a TiVO recorder) to enable the user to time-shift the viewing of video content. Broadly stated, the phrase “household device” is used herein to refer to any device, component, module, or routine that enables tune data to be collected from an associated video playback device. Household devices 104 may be stand-alone devices or household device functionality may be incorporated into the video playback devices. In some embodiments, household devices have the ability to detect, record, and communicate tuning events at each subscriber's household that are indicative of what channel a user is viewing at any given time. In addition, each household device may also have the ability to detect, record, and communicate how a user interacts with the household device such as by pressing play, fast forward, rewind, pause, etc. if the household device incorporates DVR functionality.

As shown in FIG. 1, the household devices 104 receive one or more related advertisements 11 from an advertising campaign 105 through network operators 106 and distribution channels 107. In some embodiments, the distribution channels 107 can be a digital broadcast satellite (DBS), a cable television operator (cable), a telecommunication (Telco) channel, an over-the-air (OTA) channel, or other form of wired or wireless distribution, such as coaxial cable, fiber optic cable, or a telephone line (including Digital Subscriber Line, DSL). Different network operators 106 can have different sets of distribution channels 107. For example, network operator 1 can have DBS, cable, and OTA as its distribution channels 107, while network operator 2 can have DBS, cable, and Telco as its distribution channels 107. When users watch various content including advertisements 11 that come from the network operators 16 and distribution channels 107, as noted above these activities may be recorded by the household devices 104. As will be described in more detail below, this recorded viewing information is utilized as part of the exposure and conversion analysis process.

As part of the exposure and conversion analysis system 100, a purchase data module 108a is utilized to obtain household-level purchase information 12a. Household-level purchase information reflects when a consumer in the household purchases an advertised product or service. Such purchase information 12a can be based on credit card receipts or other purchase records that can be correlated to a particular set top box or household, as will be described in more detail below with respect to FIG. 2. It will be appreciated that while the purchase information 12a is illustrated as coming directly from the households 103, that such information is typically received from aggregators of purchase information (e.g., credit card companies, payment processors, financial institutions) that are able to correlate consumer purchases with particular households or groups of households (e.g., all households within a particular geographic area). A viewing data module 108b is utilized to obtain viewing data 12b from the household devices 104. Viewing data 12b may be received directly from each household, such as based on a request from the viewing data module 108b. Alternatively, viewing data 12b from the households may be received in aggregate from network operators 106 or others having access to the household viewing data records. An advertising campaign schedule data module 108c provides schedule data, as will be described in more detail below.

An exposure and conversion module 109 receives purchase data 13a from the purchase data module 108a, viewing data 13b from the viewing data module 108b, and advertising campaign schedule data 13c from the advertising campaign schedule data module 108c. The exposure and conversion module generates data 14 for one or more exposure interaction matrices, as will be described in more detail below with respect to FIGS. 2 and 3. A displaying module 110 may display the data 14 as one or more exposure interaction matrices or related processed information (e.g. an indication of which combinations of advertisement views yield a high level of conversion, etc.) as electronic documents, hard copy reports, image files, or tables or charts displayed on a user interface. Advertisers may utilize the information generated by the exposure and conversion module 109 to determine how to maximize the conversion of advertising campaigns 105 and more efficiently spend advertising budgets.

FIG. 2 is a flowchart 200 showing an embodiment of a method for forming an exposure interaction matrix. As shown in FIG. 2, at a block 210, the system obtains access to household-level purchase information. Such purchase information can be based on credit card receipts or other purchase records that can be correlated to a particular set top box or household in a manner that does not breach the consumer's privacy. That is, for every household n, the system is able to ascertain whether a member of the household either did or did not purchase an advertised product or service. Purchase data may be obtained from the advertiser itself, or from a third party that aggregates such information, such as credit card issuers or payment processors. While purchase data is preferably obtained on a household-level basis, in some circumstances purchase data may only be available for groups of households (e.g., households in a particular zip code, town, or region). In such a case, the likelihood of any individual household within the region having made the purchase may be estimated by the system by dividing the sales for that region by the total number of households within the region.

At a block 220, the system accesses the viewing data for household n. The viewing or tune data is typically supplied by a content presenter such a cable or satellite television operator that receives tune data from all or some of the set top boxes in the operator's network. A system and method for receiving and analyzing viewing data is described in U.S. patent application Ser. No. 11/701,959, filed on Feb. 1, 2007, entitled “Systems and Methods for Measuring, Targeting, Verifying, and Reporting Advertising Impressions”, which is hereby incorporated by reference in its entirety. A system and method for correcting viewing data so as to not count exposures occurring when a television or other viewing device is off is described in U.S. patent application Ser. No. 13/081,437, filed on Apr. 6, 2011, entitled “Method and System for Detecting Non-Powered Video Playback Devices”, which is hereby incorporated by reference in its entirety.

At a block 230, the system accesses the complete advertising schedule for the campaign of interest. At a block 240, for the household n, the system reviews the household's viewing history, combined with the advertising schedule, and measures how many times the household was exposed to target ads, and how many times the household was exposed to non-target ads. A “target” portion of an advertising campaign is defined as an advertisement or set of advertisements that are presented to the household during an advertising schedule of particular interest to an advertiser (“target ads”). The target portion of the advertising schedule may be defined as occurring on a certain network (e.g., NBC, CNN), in association with a particular program (e.g., CSI, 60 Minutes), at a particular time of day (e.g., during prime time, from 1 pm-3 pm), or any combination thereof. A “non-target” portion of the advertising campaign is defined as the same advertisement or set of advertisements that are presented to the household during the remainder of the advertising schedule (i.e., during all other channels, programs, or times other than the portion of the advertising campaign being analyzed) (“non-target ads”). As will be described in more detail below, it is desirable to understand the effectiveness of the target portion of the advertising campaign in relation to the rest of the advertising campaign (the non-target portion).

At a block 250, the system assigns the household n that was exposed to this combination of target and non-target advertisements to cell (x,y) in a matrix, where x is a number of non-target exposures and y is a number of target exposures. As will be discussed in additional detail herein, FIG. 3 is a representative matrix 300 that is constructed by the system for a particular target portion of an advertising campaign. The system thereby divides the households into groups, with each group of households having the same number of target and non-target exposures to a particular ad or ads.

At block 250, the system also determines whether a conversion occurred for each household. Each household that has been assigned to a cell within the matrix 300 has associated purchase information. Using the purchase information and the information about advertisements presented to each household, the system calculates whether a conversion occurred at each household. Conversions are determined by comparing the advertisements presented to a household with the purchases made by the household. Households having viewed an advertisement and then subsequently purchased the product or service are referred to as “converted.” Households that viewed the advertisement but did not purchase the product or service, are referred to as “non-converted.” In some embodiments, various sources (e.g., advertisers, marketers, etc.) may provide the purchase information, which is associated with the specific households for determining the conversions.

At a decision block 260, the system determines if the household n was the last household in the particular geographic area being analyzed. If there are more households to be analyzed, then the system returns to the block 210 where the next household is analyzed. If the last household has been analyzed, then the system continues to a block 270.

At the block 270, a conversion rate is therefore computed by the system for each cell. The conversion rate is the ratio of the number of converted households (in the cell) to total households (including all converted plus non-converted households in the cell). At a block 280, the system computes the conversion rate for each total number of exposures, including both target and non-target exposures. That is, the system computes the percentage of households who converted when overall they were exposed to 5 ads, to 6 ads, to 7 ads, etc. At a block 290, the system computes the index for each cell. The index for each cell is the conversion rate of the cell, divided by the previously-calculated overall conversion rate for the total number of exposures that is represented by that cell (i.e., x+y for each cell). Overall, the index for each cell is therefore expressed by the following equations (1) and (2):

$$\begin{matrix}cell\_conversion \_rate ( x , y ) = \frac{number\_converted \_households ( x , y )}{total\_households ( x , y )} & Eq . ( 1 ) \\ cell\_index ( x , y ) = \frac{cell\_conversion \_rate ( x , y )}{overall\_conversion \_rate ( x + y )} & Eq . ( 2 )\end{matrix}$$

The index of each cell therefore indicates how much the target advertisements influenced the conversion decision, relative to the entire campaign.

Those skilled in the art will appreciate that the system 100 and method 200 may be implemented on any computing system or device. Suitable computing systems or devices include personal computers, server computers, minicomputers, mainframe computers, distributed computing environments that include any of the foregoing, and the like. Such computing systems or devices may include one or more processors that execute software to perform the functions described herein. Processors include programmable general-purpose or special-purpose microprocessors, programmable controllers, application specific integrated circuits (ASICs), programmable logic devices (PLDs), or the like, or a combination of such devices. Software may be stored in memory, such as random access memory (RAM), read-only memory (ROM), flash memory, or the like, or a combination of such components. Software may also be stored in one or more storage devices, such as magnetic or optical based disks, flash memory devices, or any other type of non-volatile storage medium for storing data. Software may include one or more program modules which include routines, programs, objects, components, data structures, and so on that perform particular tasks or implement particular abstract data types. In distributed computing environments, the functionality of the program modules may be combined or distributed across multiple computing systems or devices and accessed via service calls.

FIG. 3 is a diagram depicting a representative exposure interaction matrix 300 formed in accordance with the method of FIG. 2. The exposure interaction matrix 300 illustrates an example where the particular portion of the advertising campaign to be analyzed is the exposures on a particular network. As shown in FIG. 3, the number of exposures to non-target advertisements is indicated along the x-axis, while the number of exposures to target advertisements is indicated along the y-axis. Each cell includes an index value, which as noted above is the conversion rate of the cell, divided by the overall conversion rate for (x+y) exposures. As a specific illustrative example, cell (2, 4) is shown to have an index value 1.330778. This indicates that households with 4 target exposures and 2 non-target exposures were approximately 33% more likely to convert than all households with 6 (4+2) exposures. In this specific example with the index value 1.330778, the target is thus indicated to be more effective than the non-target. In a similar manner, the incremental index value of each target exposure can be measured and compared.

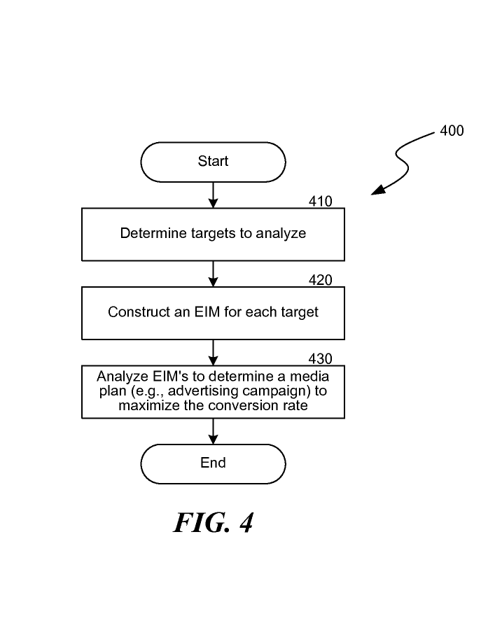

FIG. 4 is a flowchart 400 showing an embodiment of a method for determining a media plan by constructing and analyzing a series of exposure interaction matrixes. At a block 410, target advertisements are determined that will be analyzed and compared. The target advertisements may be determined in accordance with the options available to an advertiser. For example, the advertiser may be interested in comparing the performance of an advertisement presented during the morning versus the same advertisement presented in the evening. At a block 420, an exposure interaction matrix is constructed for each portion of the advertising campaign being analyzed. At a block 430, the exposure interaction matrices are analyzed to determine a media plan (e.g. an advertising campaign) that maximizes the conversion rate. In some embodiments, an advertiser or agency may use such information to calculate an optimal media plan. The algorithm can try different combinations of target and non-target exposures (across different target definitions), and calculate the resulting conversion rate. The conversion rate can thus be maximized by such methods as downhill simplex and other nonlinear optimization techniques that are well known to those skilled in the art.

As will be appreciated by those skilled in the art, the system can analyze the exposure interaction matrix to determine which combination(s) of advertisement views yield a high or desired level of conversion. The system can present the recommended combinations on a computer monitor, on paper, or store the recommended combinations on a computer readable media or transmit the recommended combinations over a computer communication link to another computer or display device. For example, the system can display the exposure interaction matrix in graphical form, with cells color-coded to reflect levels of performance. Cells indicating particularly good advertising performance may be color-coded in shades of red, whereas cells indicating poor performance may be color-coded in shades of blue. The color-coding of the matrix allows advertisers to quickly assess the various combinations reflected by the matrix and determine which areas reflect an optimal level of performance at a desired cost. With the information determined from the exposure interaction matrix, an advertiser is able to plan their advertising strategy as a combination of direct and indirect advertising exposures that will have the most likely chance of conversion for their desired customers.

From the foregoing, it will be appreciated that specific embodiments of the invention have been described herein for purposes of illustration, but that various modifications may be made without deviating from the scope of the invention. While FIG. 3 depicts a table whose contents and organization are designed to make them more comprehensible by a human reader, those skilled in the art will appreciate that the actual data structure(s) used by the system to store this information may differ from the table shown, in that it, for example, may be organized in a different manner, may contain more or less information than shown, may be compressed and/or encrypted, and may be optimized in a variety of ways. Those skilled in the art will further appreciate that the depicted flow chart may be altered in a variety of ways. For example, the order of the steps may be rearranged, steps may be performed in parallel, steps may be omitted, or other steps may be included. Accordingly, the invention is not limited except as by the appended claims.

I/We claim:

1. A method to analyze conversion data related to an advertising campaign, wherein the advertising campaign comprises a target portion and a non-target portion, the method comprising:
determining, at a household level, a number of target exposures of an advertisement from an advertising campaign, the target exposures occurring during a target portion of the campaign;
determining, at a household level, a number of non-target exposures of an advertisement from the advertising campaign, the non-target exposures occurring during a non-target portion of the campaign that is different from the target portion of the campaign;
obtaining, at a household level, purchase data related to the product or service associated with the advertisement;
generating, at a household level, conversion data by correlating the purchase data with the number of target exposures and the number of non-target exposures; and
calculating an effectiveness indicator of the advertisement for the target portion based on the number of target exposures, non-target exposures and the conversion data.

2. The method of claim 1, further comprising calculating a plurality of effectiveness indicators that each correspond to a different number of target exposures and non-target exposures.

3. The method of claim 1, wherein the effectiveness indicators correspond to different cells in an exposure interaction matrix.

4. The method of claim 3, wherein the exposure interaction matrix comprises the number of target exposures along one axis, and the number of non-target exposures along the other axis.

5. The method of claim 4, wherein the effectiveness indicators are calculated according to a ratio of a conversion rate for a particular cell relative to a conversion rate for a total number of exposures.

6. The method of claim 3, further comprising determining a plurality of exposure interaction matrices for a plurality of target portions and comparing the plurality of exposure interaction matrices to one another in order to determine a desired advertising campaign.

7. The method of claim 1, wherein the number of target exposures and non-target exposures are determined by comparing household viewing data to advertising schedule data.

8. A non-transitory computer-readable media with instructions stored thereon that when executed, cause a processor to analyze conversion data related to an advertising campaign that comprises a target portion and a non-target portion, by:
determining, at a household level, a number of target exposures of an advertisement from an advertising campaign, the target exposures occurring during a target portion of the campaign;
determining, at a household level, a number of non-target exposures of an advertisement from the advertising campaign, the non-target exposures occurring during a non-target portion of the campaign that is different from the target portion of the campaign;
obtaining, at a household level, purchase data related to the product or service associated with the advertisement;
generating, at a household level, conversion data by correlating the purchase data with the number of target exposures and the number of non-target exposures; and
calculating an effectiveness indicator of the advertisement for the target portion based on the number of target exposures, non-target exposures and the conversion data.

9. The non-transitory computer-readable media of claim 8, further comprising calculating a plurality of effectiveness indicators that each correspond to a different number of target exposures and non-target exposures.

10. The non-transitory computer-readable media of claim 9, wherein the effectiveness indicators correspond to different cells in an exposure interaction matrix.

11. The non-transitory computer-readable media of claim 10, wherein the exposure interaction matrix comprises the number of target exposures along one axis, and the number of non-target exposures along the other axis, and the effectiveness indicators are calculated according to a ratio of a conversion rate for a particular cell relative to a conversion rate for a total number of exposures.

12. The non-transitory computer-readable media of claim 10, further comprising determining a plurality of exposure interaction matrices for a plurality of target portions and comparing the plurality of exposure interaction matrices to one another in order to determine a desired advertising campaign.

13. The non-transitory computer-readable media of claim 8, wherein the number of target exposures and non-target exposures are determined by comparing household viewing data to advertising schedule data.

14. A computing system comprising:
a memory for storing a sequence of program instructions;
a processor that is configured to execute the sequence of instructions for analyzing conversion data related to an advertising campaign that comprises a target portion and a non-target portion, by:
receiving purchase data, viewing data and advertising campaign schedule data;
processing the viewing data and advertising campaign schedule data to determine, at a household level, target exposures of an advertisement from an advertising campaign and non-target exposures of an advertisement from the advertising campaign, the target exposures occurring during a target portion of the campaign and the non-target exposures occurring during a non-target portion of the campaign that is different from the target portion of the campaign; and
generating, at a household level, conversion data by correlating the purchase data with the target exposures and non-target exposures; and
determining an effectiveness indicator of the advertisement for the target portion based at least in part on the target exposures, non-target exposures and the conversion data.

15. The computing system of claim 14, further comprising calculating a plurality of effectiveness indicators that each correspond to a different number of target exposures and non-target exposures.

16. The computing system of claim 15, wherein the effectiveness indicators correspond to different cells in an exposure interaction matrix.

17. The computing system of claim 16, wherein the exposure interaction matrix comprises the number of target exposures along one axis, and the number of non-target exposures along the other axis.

18. The computing system of claim 17, wherein the effectiveness indicators are calculated according to a ratio of a conversion rate for a particular cell relative to a conversion rate for a total number of exposures.

19. The computing system of claim 16, further comprising determining a plurality of exposure interaction matrices for a plurality of target portions and comparing the plurality of exposure interaction matrices to one another in order to determine a desired advertising campaign.

20. A method to analyze conversion data related to an advertising campaign, wherein the advertising campaign comprises a target portion and a non-target portion, the method comprising:
determining, at a household level, a number of target exposures of an advertisement from the advertising campaign, the target exposures occurring during a target portion of the campaign;
determining, at a household level, a number of non-target exposures of an advertisement from the advertising campaign, the non-target exposures occurring during a non-target portion of the campaign that is different from the target portion of the campaign;
determining for each household a corresponding cell in an exposure interaction matrix based on the number of target exposures and non-target exposures;
determining how many households converted in each cell; and
calculating an effectiveness indicator for each cell based on the number of households that converted in each cell.

21. The method of claim 20, wherein the calculation of the effectiveness indicator comprises calculating a ratio of a conversion rate for each cell relative to a conversion rate for an overall number of exposures.

22. The method of claim 21, wherein the conversion rate for each cell comprises a ratio of the number of converted households in the cell relative to the total number of households in the cell.

23. The method of claim 20, further comprising determining a plurality of exposure interaction matrices for a plurality of target portions and comparing the plurality of exposure interaction matrices to one another in order to determine a desired advertising campaign.
